(19) United States
(12) Patent Application Publication
(10) Pub. No.: US 2024/0232945 A1
(43) Pub. Date: Jul. 11, 2024

(54) MACHINE LEARNING-BASED AUTOMATED TARGETING EXPANSION SYSTEM

(71) Applicant: GOOGLE LLC, Mountain View, CA (US)

(72) Inventor: Bharath Pattabiraman, Santa Clara, CA (US)

(21) Appl. No.: 18/285,613

(22) PCT Filed: Dec. 29, 2022
(86) PCT No.: PCT/US22/54225

§ 371 Date: Oct. 4, 2023

Related U.S. Application Data
(60) Provisional application No. 63/295,570, filed on Dec. 31, 2021.

(51) Int. Cl. G06Q 30/0251; G06Q 30/0201

(52) U.S. Cl. CPC G06Q 30/0256; G06Q 30/0201

(57) ABSTRACT

Systems and methods for assessing the relevancy of search queries are described. A computing device uses various machine learning techniques to determine whether a search query presents an opportunity to display content as well as determine a category for the search query and a content item associated with the category. The computing device additional analyzes an additional search query using a machine learning model with a relaxed threshold to assess relevancy. The computing device captures engagement data associated with a user engaging with the content item and update the machine learning model with the engagement data.

### CROSS-REFERENCE TO RELATED APPLICATIONS

This application claims priority to U.S. Patent Application No. 63/295,570, filed Dec. 31, 2021, the disclosure of which is hereby incorporated by reference in its entirety.

### FIELD

The present disclosure relates to assessing relevancy of search queries and, more particularly, to using machine learning techniques to assess opportunities to display content in association with search queries.

### BACKGROUND

Conventionally, search engines employ keyword-based targeting systems where a content source specifies a set of keywords on which to potentially display its content, and where a user search query that matches this set of keywords will render the content eligible to present to a user. While this technique may result in identifying opportunities to present content on a limited set of high-quality queries, the universe of relevant queries is generally much larger, and capturing these using this technique is not scalable.

Accordingly, there is an opportunity for platforms and techniques to capture a greater amount of content opportunities from a larger set of potentially relevant queries.

### SUMMARY

An example embodiment of the techniques of the present disclosure is a method of determining relevant search queries. The method includes accessing a plurality of search queries inputted into a plurality of electronic devices, and analyzing, using a first machine learning model, a first search query of the plurality of search queries to determine, according to a first threshold, that the first search query presents a first opportunity to display content. In response to determining that the first search query presents the first opportunity to display content, the method includes analyzing, by the one or more processors using a second machine learning model, the first search query to predict a category associated with the first search query, wherein a first content item associated with the category is displayed by a first electronic device of the plurality of electronic devices into which the first search query was inputted. Further, the method includes analyzing, by the one or more processors using the first machine learning model, a second search query of the plurality of search queries to determine, according to a second threshold lower than the first threshold, that the second search query presents a second opportunity to display content, in response to determining that the second search query presents the second opportunity to display content, detecting whether a user engaged with a second content item displayed by a second electronic device of the plurality of electronic devices into which the second search query was inputted, and updating, by the one or more processors, the first machine learning model with data comprising the second search query and indicating whether the user engaged with the second content item.

Another embodiment of these techniques is a system for determining relevant search queries. The system includes a memory storing a set of computer-readable instructions and data associated with a first machine learning model and a second machine learning model, and one or more processors interfaced with the memory. The one or more processors is configured to execute the set of computer-readable instructions to cause the one or more processors to access a plurality of search queries inputted into a plurality of electronic devices, analyze, using the first machine learning model, a first search query of the plurality of search queries to determine, according to a first threshold, that the first search query presents a first opportunity to display content, and in response to determining that the first search query presents the first opportunity to display content, analyze, using the second machine learning model, the first search query to predict a category associated with the first search query, wherein a first content item associated with the category is displayed by a first electronic device of the plurality of electronic devices into which the first search query was inputted. The one or more processors is further configured to analyze, using the first machine learning model, a second search query of the plurality of search queries to determine, according to a second threshold lower than the first threshold, that the second search query presents a second opportunity to display content, in response to determining that the second search query presents the second opportunity to display content, detect whether a user engaged with a second content item displayed by a second electronic device of the plurality of electronic devices into which the second search query was inputted, and update the first machine learning model with data comprising the second search query and indicating whether the user interacted with the second content item.

Yet another embodiment of these techniques is a computer-readable medium which may be non-transitory, and storing instructions thereon. The instructions, when executed by one or more processors of an electronic device, cause the one or more processors to access a plurality of search queries inputted into a plurality of electronic devices, analyze, using a first machine learning model, a first search query of the plurality of search queries to determine, according to a first threshold, that the first search query presents a first opportunity to display content, and in response to determining that the first search query presents the first opportunity to display content, analyze, using a second machine learning model, the first search query to predict a category associated with the first search query, wherein a first content item associated with the category is displayed by a first electronic device of the plurality of electronic devices into which the first search query was inputted. Further, the instructions, when executed by one or more processors of an electronic device, further cause the one or more processors to analyze, using the first machine learning model, a second search query of the plurality of search queries to determine, according to a second threshold lower than the first threshold, that the second search query presents a second opportunity to display content, in response to determining that the second search query presents the second opportunity to display content, detect whether a user engaged with a second content item displayed by a second electronic device of the plurality of electronic devices into which the second search query was inputted, and update the first machine learning model with data comprising the second search query and indicating whether the user engaged with the second content item.

### BRIEF DESCRIPTION OF THE DRAWINGS

FIG. 1 illustrates an overview of certain components in which techniques for assessing relevancy of search queries may be implemented, in accordance with some embodiments.

FIG. 2 is a diagram having components configured to train a set of machine learning models, in accordance with some embodiments.

FIG. 3 is a diagram having components configured to use a set of machine learning models to determine relevant search queries, in accordance with some embodiments.

FIG. 4 is a flow diagram of an example method of determining relevant search queries, in accordance with some embodiments.

FIG. 5 is a hardware diagram of an example server and an example electronic device configured to facilitate the described techniques, in accordance with some embodiments.

### DETAILED DESCRIPTION

Conventionally, content items such as digital advertisements that present based on search query activity employ keyword-based targeting systems in which a customer (e.g., an advertiser) specifies a set of keywords for which its content items present. In operation, a user search query that matches one of these keywords will render a relevant content item to present.

This framework is usually employed by large customers who utilize account managers or firms to set up the campaigns and targeting strategies; however, it may be a challenging endeavor for smaller customers such as small and medium-sized businesses. Currently, there are simplified setup procedures in place for these smaller customers where the selectable options to configure a campaign are intuitive and align closely with the expertise of the customers. For example, a customer may select a set of services that it offers from a predefined list of services (e.g., plumber, electrician, HVAC, etc.). As a result, content targeting becomes a query identification problem with the need to identify whether a search query is seeking a service and, if so, identify the service that is being sought. At this point, a list of search queries may be manually identified or specified (e.g., “plumber near me”, “plumbing services”, etc.) for each service. Each received search query may then be compared to this list and, if there is a match, a content item associated with that corresponding service is identified and provided to a user that initiated that search query.

These existing frameworks enable targeted content on only a limited set of queries, such as high-quality queries that offer high match potential. However, in reality, the pool of relevant queries generally extends far beyond these high-quality queries and capturing these queries using these existing frameworks is not scalable. In particular, there are often many “tail” queries (e.g., “SDM4134 repair”, “my bathroom is flooded”, etc.) that may represent a content match, and manually identifying such queries is not feasible.

Systems and methods for determining relevant search queries are described. According to certain aspects, a computing device may train and store multiple machine learning models which the computing device may use to determine whether a given search query presents an opportunity to display content, and if so, determine a category associated with that search query. The computing device may identify a content item associated with the category and transmit the content item to an electronic device that originated the search query, where the electronic device may display the content item to a user.

According to embodiments, the computing device may analyze search queries using a first machine learning model using different thresholds, to assess whether the search queries present opportunities to display content. In particular, in “main” operation, the computing device may analyze a first search query using a first threshold and, in “exploration” operation, the computing device may analyze a second search query using a second threshold lower than the first threshold. If this second search query at least meets the second threshold, the computing device may cause a content item to be displayed at an electronic device that originated the second search query. Additionally, the computing device may capture engagement data associated with the content item, and may update the first machine learning model with the second search query and the engagement data.

By analyzing additional search queries using a relaxed threshold, the systems and methods may capture additional content presentation opportunities. Additionally, by consistently and continuously updating the first machine learning model as additional search queries are analyzed using the relaxed threshold and user engagement data resulting therefrom is captured, subsequent search queries that may be similar to these additional search queries result in the systems and methods determining query relevancy while operating at the normal threshold when these additional search queries would not normally be deemed relevant prior to the first machine learning model being updated. Because additional content presentation opportunities are captured, users are afforded the benefit of being presented with more relevant content to potentially assist with the services that are being sought. It should be appreciated that the systems and methods offer additional benefits.

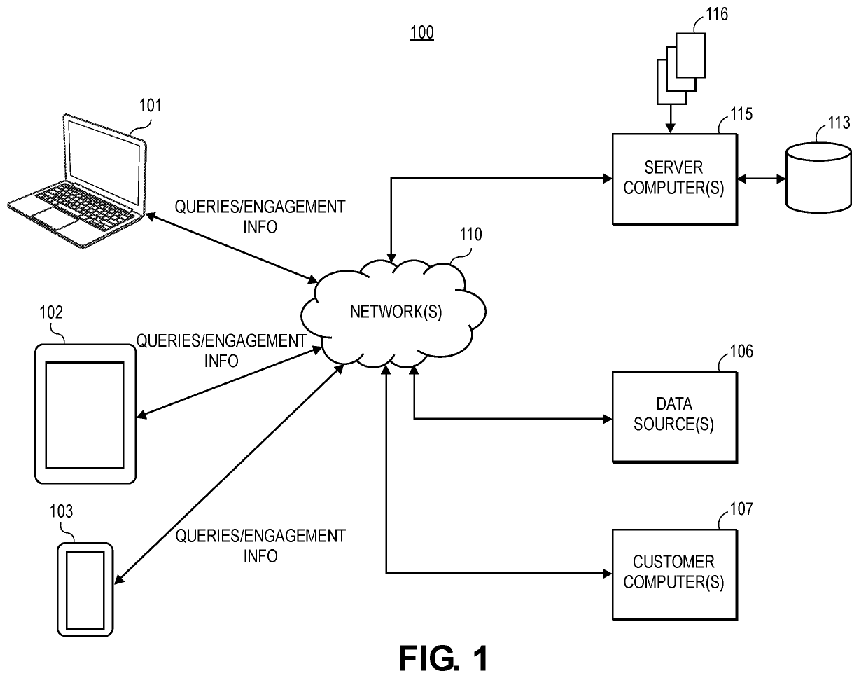

FIG. 1 illustrates an overview of a system 100 of components configured to facilitate the systems and methods. It should be appreciated that the system 100 is merely an example and that alternative or additional components are envisioned.

As illustrated in FIG. 1, the system 100 may include a set of electronic devices 101, 102, 103. Each of the electronic devices 101, 102, 103 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, each of the electronic devices 101, 102, 103 may be configured to receive one or more search queries, for example from a user via a user interface.

The electronic devices 101, 102, 103 may communicate with one or more server computers 115 via one or more networks 110. In embodiments, the network(s) 110 may support any type of data communication via any standard or technology (e.g., GSM, CDMA, VOIP, TDMA, WCDMA, LTE, EDGE, OFDM, GPRS, EV-DO, UWB, Internet, IEEE 802 including Ethernet, WiMAX, Wi-Fi, Bluetooth, 4G/5G/6G, Edge, and others). The server computer(s) 115 may be associated with an entity such as a company, business, corporation, or the like. The server computer(s) 115 may include various components that support communication with the electronic devices 101, 102, 103.

The server computer(s) 115 may communicate with one or more customer computers 107 and one or more data sources 106 via the network(s) 110. In embodiments, each of the customer computer(s) 107 may be associated with an entity such as a company, business, corporation, individual, or the like that may want to establish, have, and/or maintain a content campaign in which its content items are transmitted to and displayed by one or more of the electronic devices 101, 102, 103. The customer computer(s) 107 may cause a set of content items for the respective entity to be stored in the data source(s) 106 for access by the server computer(s) 115.

According to embodiments, the content items may be, for example, digital advertisements composed of textual and/or visual content that may be configured to be displayed by the electronic devices 101, 102, 103. For example, a content item may be a textual identification and/or description of a business, a digital image or video, a selectable phone number, or the like. A given content item may be embodied as a selectable item (e.g., a hyperlink) that may enable for engagement with a user who views or consumes the content item. For example, if a content item is a digital video, a user engagement action may constitute a user viewing the digital video. As another example, if a content item is a selectable link to a website of an entity, a user engagement action may constitute a user clicking on the selectable link.

Generally, a customer entity associated with the customer computer 107 may enter into an agreement, contract, or the like with an entity associated with the server computer(s) 115 such that the server computer(s) 115 may provide content items associated with the customer entity to one or more of the electronic devices 101, 102, 103 in response to the server computer(s) 115 determining that search queries originated and transmitted by the electronic devices 101, 102, 103 are relevant to the customer entity. In this arrangement, the data source(s) 106 may store the content items for access and retrieval by the server computer(s) 115. For example, a plumbing business in Miami, FL may have a content item embodied as a hyperlink to its website, and if a given search query is “plumber Miami”, the server computer(s) 115 may retrieve the content item from the data source(s) 106 and transmit the content item to an electronic device from which the search query is received.

To determine whether search queries are relevant to customer entities, the server computer(s) 115 may employ various machine learning analysis techniques. Initially, the server computer(s) 115 may train at least two machine learning models using a training dataset 116, where the training dataset 116 may be stored in and accessed from the data source(s) 106, or received from another source (not shown in FIG. 1). In particular, the server computer 115 may initially train a set of machine learning models using the training dataset 116 and then apply or input a validation set into a set of generated machine learning models to determine which of the machine learning models is most accurate or otherwise may be used as the final or selected machine learning model. According to embodiments, the trained machine learning models may include a first machine learning model that may be a probability prediction model and a second machine learning model that may be a standard classification model.

According to embodiments, respective users of the one or more electronic devices 101, 102, 103 may input a set of search queries into the one or more electronic devices 101, 102, 103 via respective user interfaces. For example, the users may input textual or audio queries via the user interfaces, or the set of search queries may be embodied as coded content such as a QR code, visual content such as a digital image or video, or another type of input. The set of search queries may be input into a search engine or other type of interface, application, program, and/or the like that may be supported by the one or more electronic devices 101, 102, 103.

The one or more electronic devices 101, 102, 103 may transmit the set of search queries to the server computer(s) 115 via the network(s) 110. The server computer(s) 115 may segment, partition, or group the set of search queries into a “main” group and an “exploration” group. According to embodiments, the server computer(s) 115 may analyze the search queries of the “main” group using the first machine learning model according to a first threshold to determine whether a given search query presents an opportunity to display content via the electronic device that originated that search query. Further, the server computer(s) 115 may analyze the search queries of the “exploration” group using the first machine learning model according to a second threshold to determine whether a given search query presents an opportunity to display content via the electronic device that originated that search query.

If the output of the first machine learning model indicates that there is an opportunity to display content associated with a given search query (for either a “main” search query or an “exploration” search query), the server computer(s) 115 may analyze the given search query using the second machine learning model to predict or determine a category for that search query. The server computer(s) 115 may interface with the data source(s) 106 to identify and retrieve a content item (e.g., a digital advertisement) associated with the category, and the server computer(s) 115 may transmit the content item to one of the electronic devices 101, 102, 103 that originated the search query, where that electronic device 101, 102, 103 may display the content item for viewing, reviewing, and/or engagement by a user.

According to embodiments, the user of the electronic device 101, 102, 103 may engage with the content item, where data indicative of any engagement (or non-engagement) may be generated or compiled by the electronic device 101, 102, 103 and transmitted to the server computer(s) 115 via the network(s) 110. The server computer(s) 115 may use the engagement data to update either or both of the first and second machine learning models, for use in analyses of subsequent search queries. Functionalities associated with training, using, and updating the machine learning models are discussed in more detail herein.

The server computer(s) 115 may be configured to interface with or support a memory or storage 113 capable of storing various data, such as in one or more databases or other forms of storage. According to embodiments, the storage 113 may store data or information associated with the machine learning models that are generated by the server computer(s) 115. Additionally, the server computer(s) 115 may access the data associated with the stored machine learning models to input a set of inputs into the machine learning models. In embodiments, the storage 113 may store a portion or all of the content items that may be deemed relevant to search queries such that the server computer(s) 115 may access a content item(s) from the storage 113 as an alternative to retrieving the content item(s) from the data source(s) 106.

It should be appreciated that the server computer(s) 115 may be in the form of a distributed cluster of computers, servers, machines, cloud-based services, or the like. In this implementation, an entity may utilize the distributed server computer(s) 115 as part of an on-demand cloud computing platform. Accordingly, when the electronic devices 101, 102, 103 interface with the server computer(s) 115, the electronic devices 101, 102, 103 may actually interface with one or more of a number of distributed computers, servers, machines, or the like, to facilitate the described functionalities. Further, although three (3) electronic devices 101, 102, 103 are depicted in FIG. 1, it should be appreciated that greater or fewer amounts are envisioned.

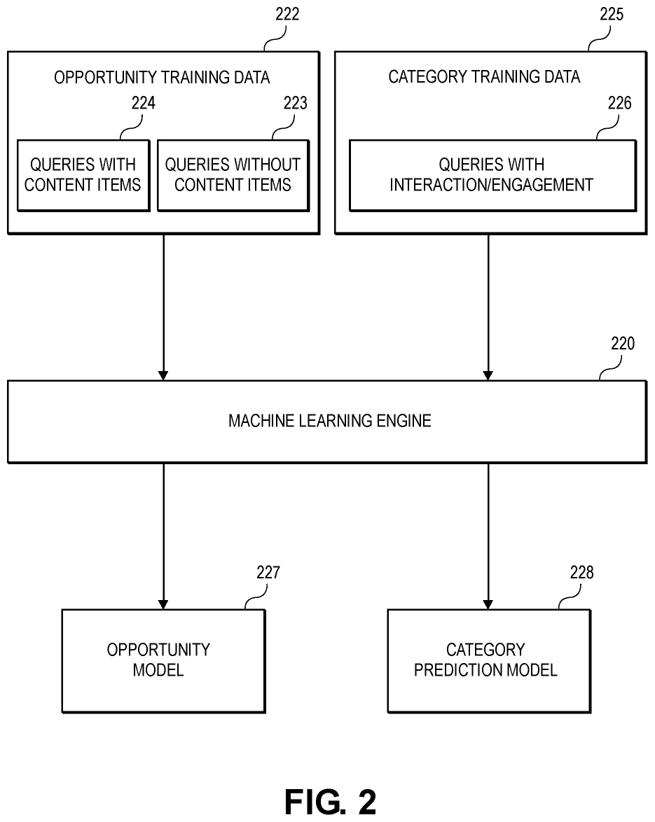

FIG. 2 schematically illustrates a diagram 200 having components configured to train a set of machine learning models. Some of the blocks in FIG. 2 represent hardware and/or software components, and other blocks represent datasets, data structures, and/or the like. According to embodiments, a machine learning engine 220 may train machine learning models using respective sets of training data. It should be appreciated that various components (e.g., the server computer(s) 115 as discussed with respect to FIG. 1) may support, implement, and/or facilitate the functionalities of the machine learning engine 220.

Block 222 represents a set of opportunity training data that may be used to train an opportunity model 227. Generally, the opportunity model 227 is a probability prediction model that may be used to determine whether a given search query presents an opportunity to display content (e.g., a digital advertisement). The opportunity training data 222 may include a set of queries with content items 224 (i.e., queries in which a content item was displayed) and a set of queries without content items 223 (i.e., queries in which a content item was not displayed). Each of the set of queries with content items 224 may be labeled with whether there was a user engagement or interaction (e.g., a “0” for “no” and a “1” for “yes”). For example, a query for “plumber near me” may have been displayed with a content item (e.g., a digital advertisement for a nearby plumber), and the user who submitted the query may have clicked on the content item (i.e., an engagement).

Generally, for a given query (e.g., “plumbers near me”), there are instances where it will have an engagement and instances where it will not have an engagement. Further, an interaction rate (IR) for a given query may be a ratio of instances with an engagement relative to the total amount of queries. Generally, a query with a strong service intent (i.e., a query that presents an opportunity for a content item) will have a higher IR, a query with a lower service intent will have a lower IR, and a query with virtually no service intent will have a very low (or zero) IR.

The machine learning engine 220 may generate the opportunity model 227 using the opportunity training data 222 and components thereof. When input data in the form of a search query (e.g., a live user search query) is input into the opportunity model 227, the opportunity model 227 may analyze the search query and output a probability that the search query presents an opportunity to display content. This probability may be compared to a threshold probability and if the outputted probability at least meets the threshold probability, then the search query is deemed to present an opportunity to display content. Conversely, if the outputted probability does not meet the threshold probability, then the search query is deemed to not present an opportunity to display content. It should be appreciated that the threshold probability is a default value, and may be configurable.

Block 225 represents a set of category prediction training data 225 that may be used to train a category prediction model 228. Generally, the category prediction model 228 is a classification model that may be used to determine a category for a given search query. The category prediction training data 225 may include a set of queries with a user interaction or engagement 226. Each of the set of queries 226 may be labeled with a category. For example, a query for “hardware store near me” may be labeled with a category of “hardware store,” and a query for “CPA San Francisco” may be labeled with a category of “accountant”.

The machine learning engine 220 may generate the category prediction model 228 using the category prediction training data 225 and components thereof. According to embodiments, if a given output of the opportunity model 227 for a search query is “yes” (i.e., the outputted probability at least meets the threshold probability), the category prediction model 228 analyzes that search query to determine or predict a category for the search query. For example, if the search query is “haircut Chicago” and the output of the opportunity model 227 is “yes”, the output from the category prediction model 228 may be “salon/barbershop.” In embodiments, the category prediction model 228 may not analyze a search query if the corresponding output from the opportunity model 227 is “no”.

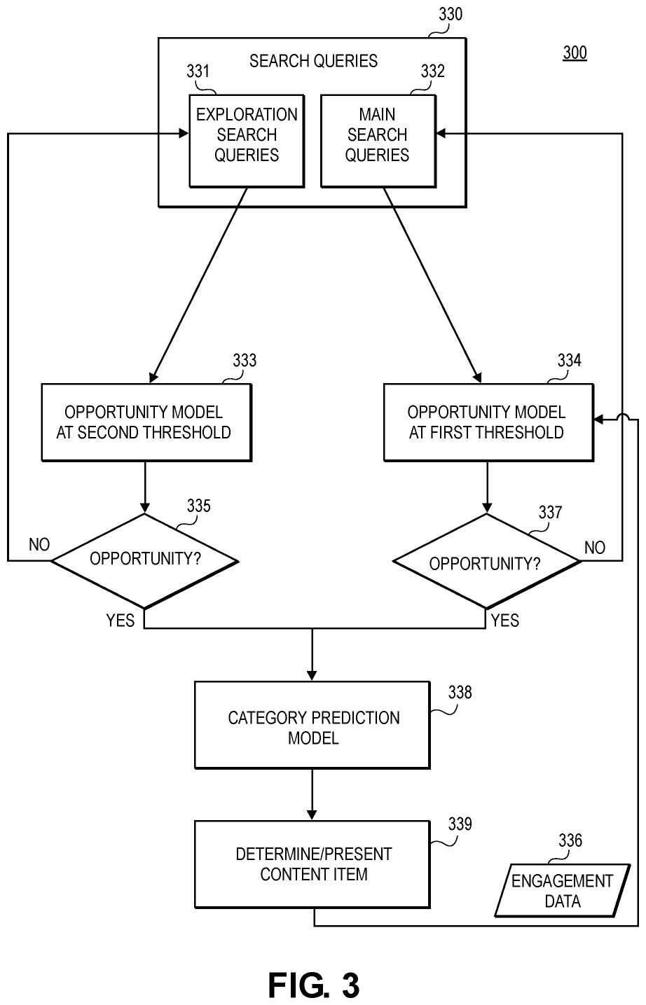

FIG. 3 schematically illustrates a diagram 300 having components configured to use a set of machine learning models to determine relevant search queries. Some of the blocks in FIG. 3 represent hardware and/or software components, and other blocks represent datasets, data structures, and/or the like. It should be appreciated that the functionalities of FIG. 3 may be facilitated after the opportunity 227 and category prediction 228 models are trained, as discussed with respect to FIG. 2. Additionally, it should be appreciated that the functionalities of FIG. 3 may be facilitated by a computer (e.g., the server computer(s) 115) that may be in communication with one or more electronic devices (e.g., the electronic devices 101, 102, 103) and one or more data sources (e.g., the data source(s) 106) and/or databases (e.g., the database 113). It should be appreciated that the opportunity model may alternatively be referred to as the “first machine learning model” and the category prediction model may alternatively be referred to as the “second machine learning model.”

FIG. 3 illustrates a set of search queries 330 which may represent search queries received by the computer from a set of electronic devices, for example in association with a search engine. The set of search queries 330 may be segmented into a set of main search queries 332 and a set of exploration search queries 331. It should be appreciated that there may (or may not be) search queries that exist in both sets of queries 332, 331, and that there may (or may not be) more search queries included in the set of main search queries 332 than in the set of exploration search queries 331.

At block 334, the computer may analyze, using the opportunity model according to a first threshold, one or more of the search queries included in the set of main search queries 332. According to embodiments, the first threshold may be a set value (e.g., 0.9) that may be configurable, whereby the output of the opportunity model may be in the form of a probability that the computer may compare to the first threshold. The computer may determine at block 337 whether that search query presents an opportunity to display content. In particular, if the outputted probability at least meets the first threshold, then the computer may deem there to be an opportunity to display content (“YES”); and if the outputted probability does not meet the first threshold, then the computer may deem there not to be an opportunity to display content (“NO”).

If there is not an opportunity (“NO”), the computer may analyze, using the opportunity model according to the first threshold, another search query from the set of main search queries 332. If there is an opportunity (“YES”) for a given search query, processing may proceed to block 338 at which the computer may analyze the given search query using the category prediction model. According to embodiments, the category prediction model may be a standard classification model, where the output from the category prediction model may be a predicted category associated with the given search query. For example, if the search query is “dinner in Manhattan”, the output from the category prediction model may be “restaurants”.

At block 339, the computer may determine a content item and cause the content item to be displayed on an electronic device that submitted the search query. In particular, the computer may retrieve, from a database (or other type of storage) of content items, a content item that matches or aligns with the category determined in block 338. The computer may transmit or send the content item to the electronic device, and the electronic device may present or display the content item for viewing or review by a user of the electronic device.

Before, concurrently with, or after the computer analyzes the set of main search queries 332 using the opportunity model according to the first threshold at block 334, the computer may also analyze (block 333), using the opportunity model according to a second threshold, one or more of the exploration search queries included in the set of exploration search queries 331. According to embodiments, the second threshold may be a set value that may be configurable, whereby the output of the opportunity model may be in the form of a probability that the computer may compare to the second threshold. Additionally, the second threshold may be lower than the first threshold. For example, the second threshold may be 0.7 and the first threshold may be 0.9.

The computer may determine at block 335 whether that exploration search query presents an opportunity to display content. In particular, if the outputted probability at least meets the second threshold, then the computer may deem there to be an opportunity to display content (“YES”); and if the outputted probability does not meet the second threshold, then the computer may deem there not to be an opportunity to display content (“NO”).

If there is not an opportunity (“NO”), the computer may analyze, using the opportunity model according to the second threshold, another search query from the set of exploration search queries 332. If there is an opportunity (“YES”) for a given exploration search query, processing may proceed to block 338 at which the computer may analyze the given exploration search query using the category prediction model, as discussed herein. Additionally, at block 339, the computer may determine a content item and cause the content item to be displayed on an electronic device that submitted the exploration search query, as discussed herein.

With respect to a content item determined for either of an exploration search query or a main search query, when the content item is displayed by the electronic device, the user may use the electronic device to interact or engage with the content item. For example, if the content item is a digital advertisement that includes a link, the user may click on or select the link using the electronic device, which may cause the electronic device to navigate to a website or webpage specified by the link. It should be appreciated that other interactions or engagements with content items are envisioned (e.g., viewing a digital image or video). The user may further interact or engage with that website or webpage. For example, if the website or webpage offers a set of products and/or services for sale, the user may purchase a product(s) and/or a service(s). Generally, if the user takes an action that is defined as valuable to a business associated with the content item (e.g., an online purchase or a call to the business), then that action may be considered a conversion. It should be appreciated that the computer may log any interactions, engagements, and/or conversions associated with a content item.

As illustrated in FIG. 3, that data resulting from a user interaction or engagement with a content item may be embodied as engagement data 336. Thus, the computer may update the opportunity model with the engagement data 336 such that, for subsequent query analyses at the first threshold, the opportunity model accounts for user engagements or interactions with content items that result from the analysis by the opportunity model at the second threshold. It should be appreciated that the electronic device or the computer may generate or create the engagement data 336 in association with a user engaging or interacting with a content item that results from either or both of the main search queries 332 or the exploration search queries 331.

As an example, one of the exploration search queries 331 may be “2700K bulbs near me”. If this search query were to be analyzed by the opportunity model at the first threshold, the computer may determine that there is not an opportunity to display content (i.e., because the outputted probability is less than the first threshold). However, when the search query is analyzed by the opportunity model at the second threshold, the computer may determine that there is an opportunity to display content (i.e., because the outputted probability at least meets the second threshold but is still less than the first threshold).

The computer may then analyze the search query using the category prediction model to determine a category for the search query, as well as determine or identify a content item associated with the category. For example, the category may be “light bulbs” and the content item may be a digital advertisement for a hardware store that sells light bulbs. An electronic device that submitted the search query may display the content item, and engagement data associated with a user interaction or engagement with the content may be captured. For example, the user may click on the digital advertisement for the hardware store or may call the number associated with the hardware store.

The engagement data may indicate the search query as well as any user or interaction with the content item, and may be used to update the opportunity model. According to embodiments, the engagement data may include the search query labeled with any engagement associated with that search query (e.g., a search query may be “specialty foods” and may be labeled with a positive or lack of user engagement). The computer may retrain and/or additionally train the opportunity model with the engagement data. In particular, the computer may update the opportunity model to include the search query that is labeled with data indicating whether the search query experienced any user engagement. The computer may analyze subsequent search queries using the opportunity model that was updated.

As a result, when the opportunity model subsequently analyzes, according to the first threshold, another search query that is the same as or similar to the original search query, the outputted probability from the opportunity model may at least meet the first threshold. For example, the search queries “3100K bulbs near me” or “adjustable color temperature light bulbs Austin” may not result in an opportunity before the opportunity model is updated with the engagement data related to the similar search query, but may result in an opportunity after the opportunity model is updated with this engagement data. Thus, the opportunity model may determine additional opportunities to display content that it would normally (i.e., without any update) not determine as an opportunity.

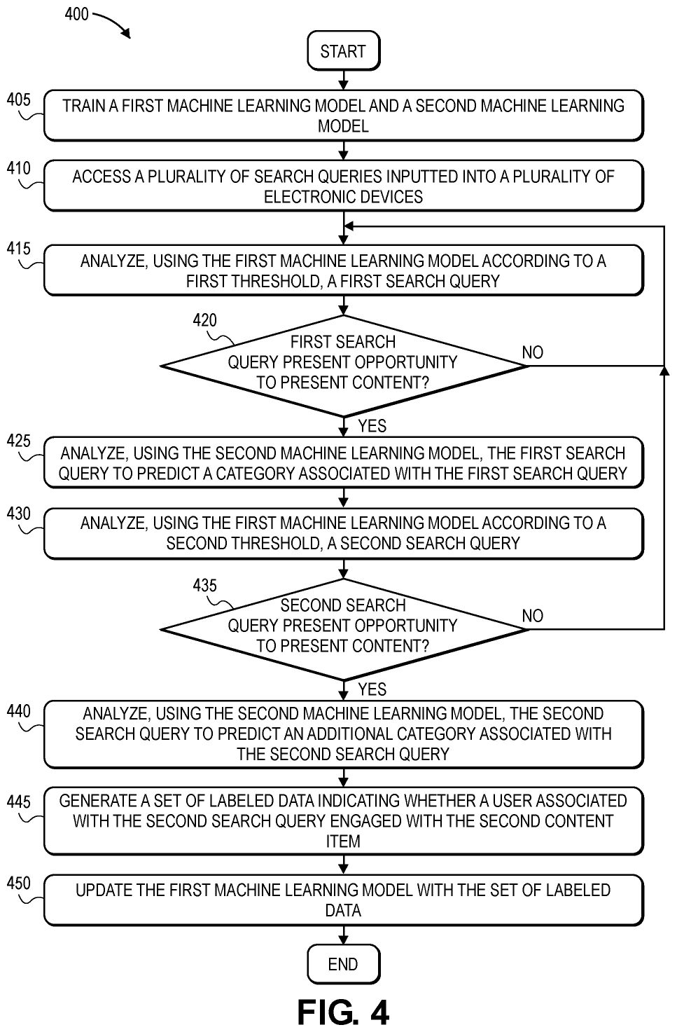

FIG. 4 depicts is a block diagram of an example method 400 of determining relevant search queries. The method 400 may be facilitated by one or more computing devices (such as one or more of the server computer(s) 115 as discussed with respect to FIG. 1) that may be configured with one or more processors. In embodiments, the computing device(s) may communicate with a set of data sources (such as the data source(s) 106 as discussed with respect to FIG. 1) and a set of electronic devices (such as the set of electronic devices 101, 102, 103.

The method 400 may begin at block 405 when the computing device(s) trains a first machine learning model and a second machine learning model, where the first machine learning model may be a probability prediction model and the second machine learning model may be a classification model. According to embodiments, the computing device(s) may train the first machine learning model using a first set of training data that may include (i) a first set of training queries where a set of content items were displayed, (ii) a first set of labeled data indicating whether a set of user engagements occurred in association with the set of content items, and (iii) a second set of training queries where content items were not displayed. Further, the computing device(s) may train the second machine learning model using a second set of training data that may include (i) at least a portion of the first set of training queries for which the set of user engagements occurred, and (ii) a second set of labeled data indicating, for each training query of at least the portion of the first set of training queries, a labeled category.

The computing device(s) may access (block 410) a plurality of search queries inputted into a plurality of electronic devices. According to embodiments, the computing device(s) may group the plurality of search queries into a first subset of search queries and a second subset of search queries that may be smaller than the first subset of search queries.

The computing device(s) may analyze (block 415), using the first machine learning model according to a first threshold, a first search query. According to embodiments, the first search query may be grouped into the first subset of search queries, and the analysis may output a probability or other metric. Based on the analysis of block 415, the computing device(s) may determine (block 420) whether the first search query presents an opportunity to display content. In particular, the computing device(s) may determine whether the outputted probability at least meets the first threshold associated with the first machine learning model.

If the first search query does not present an opportunity to display content (“NO”), processing may return to block 415 in which the computing device(s) may analyze another search query, or may end or proceed to other functionality. If the first search query does present an opportunity to display content (“YES”), processing may proceed to block 425 in which the computing device(s) may analyze, using the second machine learning model, the first search query to predict a category associated with the first search query. According to embodiments, the computing device(s) may determine and retrieve a first content item associated with the category and transmit the first content item to a first electronic device of the plurality of electronic devices into which the first search query was inputted, where the first electronic device may display the first content item to a user.

Before, concurrent with, or after the computing device(s) analyzes the first search query in block 415, the computing device(s) may analyze (block 430), using the first machine learning model according to a second threshold, a second search query. According to embodiments, the second threshold may be lower than the first threshold. Further, the second search query may be grouped into the second subset of search queries, and the analysis may output a probability or other metric. It should be appreciated that the second threshold may be adjusted at any point, where the computing device(s) may analyze a given search query using the adjusted second threshold. Based on the analysis of block 430, the computing device(s) may determine (block 435) whether the second search query presents an opportunity to display content. In particular, the computing device(s) may determine whether the outputted probability at least meets the second threshold associated with the second machine learning model.

If the second search query does not present an opportunity to display content (“NO”), processing may return to block 415 in which the computing device(s) may analyze another search query, or may end or proceed to other functionality (e.g., block 430). If the second search query does present an opportunity to display content (“YES”), processing may proceed to block 440 in which the computing device(s) may analyze, using the second machine learning model, the second search query to predict an additional category associated with the second search query. According to embodiments, the computing device(s) may determine and retrieve a second content item associated with the additional category and transmit the second content item to a second electronic device of the plurality of electronic devices into which the second search query was inputted, where the second electronic device may display the second content item to a user.

The computing device(s) may detect whether the user engaged with the second content item displayed by the second electronic device. In particular, the computing device(s) may generate (block 445) a set of labeled data indicating whether a user associated with the second search query engaged with the second content item. It should be appreciated that the user engagement may be any interaction, such as a click or selection of a link, a viewing a digital image or video, and/or the like. The computing device(s) may update (block 450) the first machine learning model with the set of labeled data and the second search query, so that the computing device(s) may access the updated first machine learning model for subsequent analyses of other search queries.

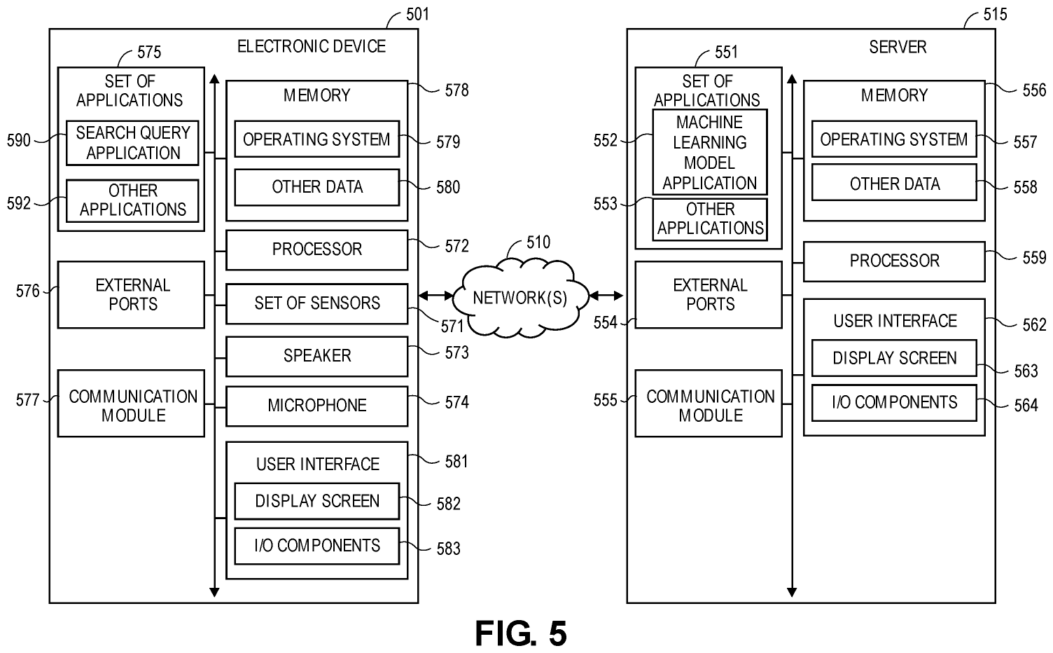

FIG. 5 illustrates a hardware diagram of an example electronic device 501 (e.g., operated by the user to input search queries as described herein) and an example server 515 (e.g., used to analyze search queries and provide content items as disclosed herein), in which the functionalities as discussed herein may be implemented.

The electronic device 501 may include a processor 572 as well as a memory 578. The memory 578 may store an operating system 579 capable of facilitating the functionalities as discussed herein as well as a set of applications 575 (i.e., machine readable instructions). For example, one of the set of applications 575 may be a search query application 590, such as an internet browser that accesses a search engine into which search queries may be input.

The processor 572 may interface with the memory 578 to execute the operating system 579 and the set of applications 575. According to some embodiments, the memory 578 may also store other data 580 that may include user engagement data, and/or other data. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 501 may further include a communication module 577 configured to communicate data via one or more networks 510. According to some embodiments, the communication module 577 may include one or more transceivers (e.g., WAN, WWAN, WLAN, and/or WPAN transceivers) functioning in accordance with IEEE standards, 3GPP standards, or other standards, and configured to receive and transmit data via one or more external ports 576.

The electronic device 501 may include a set of sensors 571 such as, for example, a location module (e.g., a GPS chip), an image sensor, an accelerometer, a clock, a gyroscope (i.e., an angular rate sensor), a compass, a yaw rate sensor, a tilt sensor, telematics sensors, and/or other sensors. The electronic device 501 may further include a user interface 581 configured to display information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs, and/or built in or external keyboard). According to some embodiments, the user may access the electronic device 501 via the user interface 581 to input search queries and/or perform other functions. Additionally, the electronic device 501 may include a speaker 573 configured to output audio data and a microphone 574 configured to detect audio.

In some embodiments, the electronic device 501 may perform the functionalities as discussed herein as part of a “cloud” network or may otherwise communicate with other hardware or software components within the cloud to send, retrieve, or otherwise analyze data.

As illustrated in FIG. 5, the electronic device 501 may communicate and interface with the server 515 via the network(s) 510. The server 515 may include a processor 559 as well as a memory 556. The memory 556 may store an operating system 557 capable of facilitating the functionalities as discussed herein as well as a set of applications 551 (i.e., machine readable instructions). For example, one of the set of applications 551 may be a machine learning model application 552 configured to train and utilize machine learning models. It should be appreciated that one or more other applications 553 are envisioned.

The processor 559 may interface with the memory 556 to execute the operating system 557 and the set of applications 551. According to some embodiments, the memory 556 may also store machine learning model data 558, such as training data and/or other data for use by the server 515 in association with any machine learning models. The memory 556 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 515 may further include a communication module 555 configured to communicate data via the one or more networks 510. According to some embodiments, the communication module 555 may include one or more transceivers (e.g., WAN, WWAN, WLAN, and/or WPAN transceivers) functioning in accordance with IEEE standards, 3GPP standards, or other standards, and configured to receive and transmit data via one or more external ports 554. For example, the communication module 555 may receive, from the electronic device 501, a set of search queries.

The server 515 may further include a user interface 562 configured to display information to a user and/or receive inputs from the user. As shown in FIG. 5, the user interface 562 may include a display screen 563 and I/O components 564 (e.g., ports, capacitive or resistive touch sensitive input panels, keys, buttons, lights, LEDs, external or built in keyboard). According to some embodiments, the user may access the server 515 via the user interface 562 to review information, make changes, and/or perform other functions.

In some embodiments, the server 515 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 572, 559 (e.g., working in connection with the respective operating systems 579, 557) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data.” “content.” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing.” “computing.” “calculating,” “determining,” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for generating navigation directions according to road surface types through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method of determining relevant search queries, the computer-implemented method comprising:
accessing, by one or more processors, a plurality of search queries inputted into a plurality of electronic devices;
analyzing, by the one or more processors using a first machine learning model, a first search query of the plurality of search queries to determine, according to a first threshold, that the first search query presents a first opportunity to display content;
in response to determining that the first search query presents the first opportunity to display content, analyzing, by the one or more processors using a second machine learning model, the first search query to predict a category associated with the first search query, wherein a first content item associated with the category is displayed by a first electronic device of the plurality of electronic devices into which the first search query was inputted;
analyzing, by the one or more processors using the first machine learning model, a second search query of the plurality of search queries to determine, according to a second threshold lower than the first threshold, that the second search query presents a second opportunity to display content;
in response to determining that the second search query presents the second opportunity to display content, detecting whether a user engaged with a second content item displayed by a second electronic device of the plurality of electronic devices into which the second search query was inputted; and
updating, by the one or more processors, the first machine learning model with data comprising the second search query and indicating whether the user engaged with the second content item.

2. The computer-implemented method of claim 1, further comprising:
in response to analyzing the second search query using the first machine learning model, analyzing, by the one or more processors using the second machine learning model, the second search query to predict an additional category associated with the second search query, wherein the second content item is associated with the additional category.

3. The computer-implemented method of claim 1, wherein updating the first machine learning model comprises:
generating, by the one or more processors, a set of labeled data indicating whether the user engaged with the second content item; and
updating, by the one or more processors, the first machine learning model with the set of labeled data.

4. The computer-implemented method of claim 1, further comprising:
training, by the one or more processors, the first machine learning model using a first set of training data comprising (i) a first set of training queries where a set of content items were displayed, (ii) a first set of labeled data indicating whether a set of user engagements occurred in association with the set of content items, and (iii) a second set of training queries where content items were not displayed.

5. The computer-implemented method of claim 4, further comprising:
training, by the one or more processors, the second machine learning model using a second set of training data comprising (i) at least a portion of the first set of training queries for which the set of user engagements occurred, and (ii) a second set of labeled data indicating, for each training query of at least the portion of the first set of training queries, a labeled category.

6. The computer-implemented method of claim 1, wherein accessing the plurality of search queries inputted into the plurality of electronic devices comprises:
grouping, by the one or more processors, the plurality of search queries into a first subset of search queries into which the first search query is grouped and a second subset of search queries, smaller than the first subset of search queries, into which the second search query is grouped.

7. The computer-implemented method of claim 1, wherein analyzing, using the first machine learning model, the second search query of the plurality of search queries comprises:
adjusting, by the one or more processors, the second threshold; and
analyzing, by the one or more processors using the first machine learning model, the second search query of the plurality of search queries to determine, according to the second threshold that was adjusted, that the second search query presents the second opportunity to display content.

8. A system for determining relevant search queries, comprising:
a memory storing a set of computer-readable instructions and data associated with a first machine learning model and a second machine learning model; and
one or more processors interfaced with the memory, and configured to execute the set of computer-readable instructions to cause the one or more processors to:
access a plurality of search queries inputted into a plurality of electronic devices,
analyze, using the first machine learning model, a first search query of the plurality of search queries to determine, according to a first threshold, that the first search query presents a first opportunity to display content,
in response to determining that the first search query presents the first opportunity to display content, analyze, using the second machine learning model, the first search query to predict a category associated with the first search query, wherein a first content item associated with the category is displayed by a first electronic device of the plurality of electronic devices into which the first search query was inputted,
analyze, using the first machine learning model, a second search query of the plurality of search queries to determine, according to a second threshold lower than the first threshold, that the second search query presents a second opportunity to display content,
in response to determining that the second search query presents the second opportunity to display content, detect whether a user engaged with a second content item displayed by a second electronic device of the plurality of electronic devices into which the second search query was inputted, and
update the first machine learning model with data comprising the second search query and indicating whether the user interacted with the second content item.

9. The system of claim 8, wherein the one or more processors is configured execute the set of computer-readable instructions to further cause the one or more processors to:
in response to analyzing the second search query using the first machine learning model, analyze, using the second machine learning model, the second search query to predict an additional category associated with the second search query, wherein the second content item is associated with the additional category.

10. The system of claim 8, wherein to update the first machine learning model, the one or more processors is configured to:
generate a set of labeled data indicating whether the user engaged with the second content item, and
update the first machine learning model with the set of labeled data.

11. The system of claim 8, wherein the one or more processors is configured execute the set of computer-readable instructions to further cause the one or more processors to:
train the first machine learning model using a first set of training data comprising (i) a first set of training queries where a set of content items were displayed, (ii) a first set of labeled data indicating whether a set of user engagements occurred in association with the set of content items, and (iii) a second set of training queries where content items were not displayed.

12. The system of claim 11, wherein the one or more processors is configured execute the set of computer-readable instructions to further cause the one or more processors to:
train the second machine learning model using a second set of training data comprising (i) at least a portion of the first set of training queries for which the set of user engagements occurred, and (ii) a second set of labeled data indicating, for each training query of at least the portion of the first set of training queries, a labeled category.

13. The system of claim 8, wherein the one or more processors is configured execute the set of computer-readable instructions to further cause the one or more processors to:
group the plurality of search queries into a first subset of search queries into which the first search query is grouped and a second subset of search queries, smaller than the first subset of search queries, into which the second search query is grouped.

14. The system of claim 8, wherein to analyze, using the first machine learning model, the second search query of the plurality of search queries, the one or more processors is configured to:
adjust the second threshold, and
analyze, using the first machine learning model, the second search query of the plurality of search queries to determine, according to the second threshold that was adjusted, that the second search query presents the second opportunity to display content.

15. A computer-readable medium configured to store instructions executable by one or more computer processors, the instructions comprising:
instructions for accessing a plurality of search queries inputted into a plurality of electronic devices;
instructions for analyzing, using a first machine learning model, a first search query of the plurality of search queries to determine, according to a first threshold, that the first search query presents a first opportunity to display content;
instructions for, in response to determining that the first search query presents the first opportunity to display content, analyzing, using a second machine learning model, the first search query to predict a category associated with the first search query, wherein a first content item associated with the category is displayed by a first electronic device of the plurality of electronic devices into which the first search query was inputted;
instructions for analyzing, using the first machine learning model, a second search query of the plurality of search queries to determine, according to a second threshold lower than the first threshold, that the second search query presents a second opportunity to display content;
instructions for, in response to determining that the second search query presents the second opportunity to display content, detecting whether a user engaged with a second content item displayed by a second electronic device of the plurality of electronic devices into which the second search query was inputted; and
instructions for updating the first machine learning model with data comprising the second search query and indicating whether the user engaged with the second content item.

16. The computer-readable medium of claim 15, wherein the instructions further comprise:
instructions for, in response to analyzing the second search query using the first machine learning model, analyzing, using the second machine learning model, the second search query to predict an additional category associated with the second search query, wherein the second content item is associated with the additional category.

17. The computer-readable medium of claim 15, wherein the instructions for updating the first machine learning model comprise:
instructions for generating a set of labeled data indicating whether the user engaged with the second content item; and
instructions for updating the first machine learning model with the set of labeled data.

18. The computer-readable medium of claim 15, wherein the instructions further comprise:
instructions for training the first machine learning model using a first set of training data comprising (i) a first set of training queries where a set of content items were displayed, (ii) a first set of labeled data indicating whether a set of user engagements occurred in association with the set of content items, and (iii) a second set of training queries where content items were not displayed; and
instructions for training the second machine learning model using a second set of training data comprising (i) at least a portion of the first set of training queries for which the set of user engagements occurred, and (ii) a second set of labeled data indicating, for each training query of at least the portion of the first set of training queries, a labeled category.

19. The computer-readable medium of claim 15, wherein the instructions for accessing the plurality of search queries inputted into the plurality of electronic devices comprise:
instructions for grouping the plurality of search queries into a first subset of search queries into which the first search query is grouped and a second subset of search queries, smaller than the first subset of search queries, into which the second search query is grouped.

20. The computer-readable medium of claim 15, wherein the instructions for analyzing, using the first machine learning model, the second search query of the plurality of search queries comprise:
instructions for adjusting the second threshold; and
instructions for analyzing, using the first machine learning model, the second search query of the plurality of search queries to determine, according to the second threshold that was adjusted, that the second search query presents the second opportunity to display content.
